(19) United States
(12) Patent Application Publication
(10) Pub. No.: US 2003/0132425 A1
(43) Pub. Date: Jul. 17, 2003

(54) Application of a flame retardant and mold inhibitor penetrant composition to porous interior building material surfaces

(76) Inventors: Jon Lee Curzon, Atlanta, GA (US); Thomas William Smoot, Alpharetta, GA (US)

Correspondence Address: Jon L. Curzon, 3331 Romelie Drive, Atlanta, GA, 30340, US

(21) Appl. No.: 10/176,411

(22) Filed: Jun. 19, 2002

Related U.S. Application Data
(60) Provisional application No. 60/348,543, filed on Jan. 16, 2002.

(51) Int. Cl. C09K 21/00

(52) U.S. Cl. 252/601

(57) ABSTRACT

A process for the single application of one (1) to ten (10) treatments of a penetrating aqueous chemical composition to impart the combined properties to retard fire and inhibit mold growth on Gypsum Wall Board, Ceiling Tiles, Joint Compounds, Concrete, Wood or Manufactured Wood products and other porous interior building material surfaces. The primary embodiment consists of a composition containing Potassium based salts, a Boron containing compound, a registered commercial mold inhibitor and a surfactant, all of which are compounded as an aqueous solution of the chemicals. Other embodiments in addition to the above can include, but are not limited too, inorganic and organic salts of Alkali Metals, such as, but not limited to, Potassium, Sodium, Lithium, Magnesium, Carbonates, Acetates, Phosphates, Citrates, Lactates or Urea, Halogens, Ammonia or any combination of these materials.

We claim the priority of Provisional Application No. 60/348,543 Filing/Receipt Date Jan. 16, 2002.

### BACKGROUND OF THE INVENTION

The present invention relates to a, combined property, penetrating fire retardant, and mold inhibiting aqueous chemical composition that may be applied as a single application to one side or both sides of porous building material surfaces. Treatment may be made either prior to installation or after first coat or finish coat paints, coatings, joint tape or compounds when applied to Gypsum Wall Board, Ceiling Tile surfaces or any other porous substrate, such as Concrete, Wood or Manufactured Wood Products. This will allow the, combined property, penetrating fire retardant and mold inhibitor to be applied to the uncoated building material and/or to the first coat or finish coat paint, or coatings. This accords simplicity, flexibility and versatility of application resulting in a finished product with a significantly reduced ASTM class I. flame spread and smoke generation index and accords antimicrobal mold inhibition properties.

Gypsum Wall Board and Tile are utilized extensively in the USA and many other developed countries for interior walls an ceilings. Surface finishing is required for the paper board substrate to cover blemishes, joint tape, nail holes and other irregularities. First and finish coat paints and coatings are applied through spraying, brushing, wiping, rolling or immersing. Numerous fire retardant, and mold inhibitor paints or coatings, instead of penetrants, are presently utilized for reducing the flame spread, smoke generation and mold growth properties of interior building materials. Those familiar with the current practice for treating wall board will recognize that surface treatment is reserved for application to only one side of the wall board that faces the enclosure interior. It can be advantageous for flame spread and mold growth reduction, to treat both sides of the paper binding the board. There is a need to improve the process, and compositions for the application of fire retardant, and mold inhibition substances to interior building materials for new construction as well as for refinished or rehabilitated interiors. The present invention will result in further prohibiting the loss of life or property.

ASTM -E84-97a “Standard Test Method for Surface Burning Characteristics of Building Materials” defines the methods utilized to test the comparative surface burning behavior of exposed building materials such as walls and ceilings. The flame spread and smoke density developed index are reported. The reported values are regarded as the standard. Class I. Fire ratings require a one (1) to twenty-five (25) index for flame spread and for smoke generation. compound, a penetrating surfactant and a mold inhibitor, all of which are compounded as an aqueous solution of the chemicals. Other chemical embodiments in addition to the above can include, but is not limited to, inorganic and organic salts of Alkali Metals, such as Potassium, Sodium, Magnesium Carbonates, Acetates, Phosphates, Citrates, Lactates, or Halogens and Ammonia, Urea or any combination of the materials. A surfactant of the Cationic, Anionic or Nonionic type is added to the aqueous fire retardant composition to provide penetrating properties to the composition. Another object of the invention is lo include in the composition a cationic surfactant that enhances the penetrating ability of the composition. Another object of the invention is to include in the composition an antimicrobial, mold inhibiting compound that is a commercial registered product.

### DETAILED DESCRIPTION OF THE PREFERRED EMBODIMENTS

It is known in the art that fire retardant paints and mold inhibitors can be applied to new construction non-coated production run Gypsum Wall Board to enhance fire retardant and mold resistance properties. One of the disadvantages of applying flame retardant, or mold inhibiting surface coatings or paint, to production run untreated board, is that the paper substrate binding the gypsum is surface coated but not penetrated and becomes the primary source of flame spread or mold. It has been found that an improved method for applying flame retardant and mold inhibiting properties can be achieved by applying one (1) to ten (10) treatments of a, combined property, penetrating aqueous fire retardant, mold inhibiting composition at the rate of one(1) gallon per 300 to 600-square feet per treatment. This results with a significant reduction in the flame spread index, the time required to reach maximum flame spread and mold growth. The preferred embodiment is the application of two (2) treatments of the, combined property, penetrating fire retardant and mold inhibiting composition at the rate of one(l) gallon per 500 square feet.

It is known in the art that fire retardant paints and mold inhibiting compositions can be applied to Gypsum Wall Board that is to be refinished or rehabilitated for the purpose of enhancing fire retardant and mold inhibiting properties. One of the disadvantages of applying flame retardant paints or mold inhibitors for refinishing or rehabilitating is that the layers of paint and the paper substrate binding the gypsum are not penetrated by the newly applied finish surface coat of paint or mold inhibiting compositions. It has been found that an improved method of applying flame retardant and mold inhibiting properties can be achieved by applying one (1) to (10) treatments of a penetrating aqueous fire retardant, mold inhibiting composition at the rate of one (1) gallon per 300 to 600 square feet per treatment. The result is a significant reduction in the time required to reach maximum flame spread and mold growth. The preferred embodiment is the application of two (2) treatments of the, combined property, penetrating fire retardant and mold inhibiting composition at the rate of one (1) gallon per 500 square feet.

The more effective suppression effectiveness of Potassium based compounds is well documented and practiced in the art. The Potassium based solution in the fire retardant composition contains about twenty percent (20%) to forty-five percent (45%) Potassium Carbonate, most preferably between about thirty percent (30%) to about forty-two percent (42%) by weight. The Potassium salt of the organic acid is present in the amount of between five percent (5%) and about thirty (30%) by weight, most preferably between ten percent (10%) and twenty-five (25%). The solubility of the Potassium salt of the organic acid is preferably 150 grams in 100 milliliters of water and contains at least 6 carbon atoms. The boron containing material is boric acid, and is present in an amount between four tenths percent (0.4%) and ten percent (10%) by weight, and most preferably between two percent (2%) and six percent (6%) by weight. The remaining weight of the solution is to be water, a cationic surfactant and an antimicrobial mold inhibiting registered commercial compound.

The use of Cationic, Anionic and Nonionic surfactants are well known for increasing the penetration of solutions into various substrates. It has been found that a Cationic Surfactant is added and present in an amount between two tenths percent (0.2%) and five percent (5%) by weight is preferable, and more preferably between three tenths percent (0.3%) and 3% by weight and most preferably one (1%) by weight. It was found that the Cationic surfactant allowed the aqueous fire retardant and mold inhibiting composition to be absorbed and penetrate the paper binding of the gypsum board within about three (3) to five (5) minutes. The time for the fire retardant composition, that did not contain the surfactant, to be absorbed was about 10 minutes. Penetration or wetting of the paper binding the Gypsum Board was diminished or absent when the surfactant was not utilized.

The use of antimicrobial, mold inhibiting compounds are well known for fungal resistance and mold growth retardation. It has been found that registered commercial mold inhibitors may be added and present in an amount of two tenths percent (0.2%) and six (6%) by weight and most preferably seven tenths percent (0.7%) by weight. It was found that the fire retardant and mold inhibiting composition without fungal resistant mold inhibitors resulted in sparse fungal colonization. Varios-compatible mold inhibiting compounds added to the penetrating fire retardant and mold inhibiting composition resulted in no fungal colonization.

### EXAMPLE I

Commercial Testing Laboratories, Dalton, Ga. performed ASTM E-84-97a “Standard Test Method for Surface Burning Characteristics of Building Materials” for test samples of treated with the invention composition and untreated Gypsum Board. The results were as follows:

| | Flame Spread > | Time to Maximum | Maximum Distance |
|---|---|---|---|
| Type | Index | Flame Spread | Flame Spread |
| (A) New Construction untreated Board | 16.2 | 1.55 minutes | 3.47 feet |
| (B) New Construction treated Board | 9.7 | 8.30 minutes | 2.36 feet |
| (C) New Construction treated and painted Board | 7.7 | 1.25 minutes | 1.57 feet |

| | |
|---|---|
| (D) 5 coats Repainted untreated Board | Burned through the paper binder into the Gypsum |
| | and caused structural deterioration to the Gypsum |
| (E) 5 coats Repainted treated Board | Charred the paper binder but did not break through |
| | the paper structure and did not deteriorate the board. |

### EXAMPLE II

(A) Interface Research Corporation, Kennesaw Ga., performed an ASTM 3273-94 evaluation of the fungal resistant properties of the penetrating flame retardant ad mold inhibiting composition. The composition was dosed with seven tenths percent (0.7%) by weight of an EPA registered antimicrobial compound and applied to both paper surfaces of gypsum board. Additional gypsum board samples were treated with the penetrating composition without the EPA registered antimicrobial compound. Other gypsum board samples were not treated. Extensive colonization, of the untreated paper surface of the gypsum board, by “Aspergillus flavus” and several species of “Penicillum” was noted. The gypsum board treated with the penetrating composition without the EPA registered antimicrobial compound only had sparse colonization by the same species. No fungal colonization was noted on the gypsum board with the penetrating composition with seven tenths percent (0.7%) of the EPA registered antimicrobial compound.

(B). Interface Research Corporation, Kennesaw Ga. performed an ASTM 3273-94 test to evaluate the fungal resistant properties of the penetrating flame retardant and mold inhibiting composition on painted surfaces with no EPA registered antimicrobial compound. Two (2) treatments of the composition were applied to the enclosure interior face of the gypsum board having up to five (5) coats of paint on the surface. A finish coat of paint was then applied to the surface. The result was that no fungal colonization was noted on the gypsum board interior face paper surface.

(C) North American Science Associates, Inc (NAMSA) an international commercial testing laboratory performed an ASTM G-21-96 test to evaluate the fungal resistant properties of the penetrating flame retardant and mold resistant composition. Treated and untreated, painted and unpainted new construction production run gypsum board test specimens were prepared according to the ASTM test requirements. The composition was applied on both sides of the paper substrate binding the gypsum board test specimens. No mold growth was observed on the surfaces or cut edges of the board after the 28 day evaluation period specified in ASTM G-21-96, resulting with a zero (0) rating. Untreated test specimens generated heavy mold growth on the surface and cut edges of the board on both sides of the paper substrate binding the board, resulting with a maximum of four (4) rating.

What is claimed

1. A process for applying one (1) to ten (10) treatments at the rate of one gallon per 300 to 600 square feet, of an aqueous combined property, flame retardant and mold inhibiting penetrating composition, with a single application per treatment to new construction production run Gypsum Wall Board.

2. A process for applying two (2 ) treatments, at the rate of one (1) gallon per 500 square feet of an aqueous combined property, flame retardant penetrating composition, with a single application per treatment to new construction production run Gypsum Wall Board, as a preferred mode.

3. A process for applying one (1) to ten (10) treatments, at the rate of one (1) gallon per 300 to 600 square feet, of an aqueous combined property, flame retardant and mold inhibiting penetrating composition, with a single application per treatment to previously painted Gypsum Wall Board, for refinishing or rehabilitating by repainting.

4. A process for applying two (2) treatments, at the rate of one (1) gallon per 500 square feet, of an aqueous combined property, flame retardant and mold inhibiting penetrating composition, with a single application per treatment to previously painted Gypsum Wall Board, for refinishing or rehabilitating by repainting, as a preferred mode.

5. The addition of a Cationic, Anionic or Nonionic surfactants to flame retardant and mold inhibiting penetrating aqueous compositions.

6. An aqueous, combined property, fire retardant and mold inhibiting penetrating composition applied with a single application by brushing, spraying, wiping or immersing to Gypsum Wall Board, Ceilings, Joint Compounds and Tape, Concrete, Wood or Manufactured Wood products and other porous interior building material surfaces.

7. An aqueous, combined property, fire retardant and mold inhibiting penetrating composition applied with a single application to Gypsum Wall Board, Ceilings, Joint Compounds and Tape, Concrete, Wood or Manufactured Wood products and other porous interior building material surfaces composed of Inorganic and Organic salts of Alkali metals, such as, but not limited, to Potassium, Sodium, Magnesium and Lithium Carbonates, Acetates, Phosphates, Citrates, Lactates, or Urea, Halogens and Ammonia or any combination of these materials plus a boron containing compound such as, but not limited to, boric acid.

8. An aqueous fire retardant penetrating composition, applied to Gypsum Wall Board, Ceiling Tile, Joint Compounds, Joint Tape, Concrete, Wood or Manufactured Wood products and other porous interior building material surfaces, containing Potassium Carbonate in the amount of twenty percent (20%) to forty-five percent (45%) by weight, a Potassium salt of an organic acid in the amount of five percent (5%) to twenty-five percent (25%) by weight, and Boric acid or Boron containing compounds in the amount of two percent (2%) to six percent (6%) by weight with the remaining weight being water, as a preferred mode.

9. An aqueous fire retardant penetrating composition, applied to Gypsum Wall Board. Ceiling Tile, Joint Compounds, Joint Tape, Concrete, Wood or Manufactured Wood products and other porous interior building material surfaces, containing Potassium Carbonate in the amount of thirty five percent (35%) by weight, Potassium Acetate in the amount of thirteen percent (13%) by weight and Boric Acid in the amount of two percent (2%) by weight with the remaining weight being water, as a most preferred mode.

10. An addition of a Cationic surfactant to the penetrating fire retardant composition, in claim 9, in the amount of two tenths percent (0.2%) to five (5%) by weight to the composition.

11. An addition of a Cationic surfactant to the penetrating fire retardant composition, in claim 9, in the amount of one percent (1%) by weight, as a preferred mode.

12. An addition to the fire retardant composition, in claim 9, of a registered commercial antimicrobial mold inhibiting compound to the composition in the amount of two tenths percent (0.2%) to six percent (6%) by weight.

13. An addition to the fire retardant composition, in claim 9, of a registered commercial antimicrobial mold inhibiting compound to A* composition of seven tenths percent (0.7%) by weight, as a preferred mode.

14. An aqueous, combined property, fire retardant and mold inhibiting penetrating composition that can be applied with one (1) to ten (10) treatments at the rate of one (1) gallon per 300 to 600 square feet per gallon, with a single application to both sides of the paper binding gypsum wallboard.
